(19) United States
(12) Patent Application Publication
(10) Pub. No.: US 2016/0170873 A1
(43) Pub. Date: Jun. 16, 2016

(54) INFORMATION PROCESSING DEVICE

(71) Applicant: HITACHI, LTD., Tokyo (JP)

(72) Inventors: Hiroshi UCHIGAITO, Tokyo (JP); Seiji MIURA, Tokyo (JP); Takumi NITO, Tokyo (JP)

(21) Appl. No.: 14/905,702

(22) PCT Filed: Jul. 18, 2013
(86) PCT No.: PCT/JP2013/069481

§ 371 Date: Jan. 15, 2016

(51) Int. Cl. G06F 12/02; G06F 3/06

(52) U.S. Cl. CPC G06F 12/0253; G06F 3/0608; G06F 3/0652; G06F 3/0659; G06F 3/0679; G06F 2212/1044; G06F 2212/7205

(57) ABSTRACT

An information processing device includes a host and a memory subsystem. The host issues a write command or an erase command with tag information corresponding to data to the memory subsystem and includes an information processing circuit for processing the data. The memory subsystem includes a first memory, a second memory, and a memory subsystem control circuit. The first memory stores management information for managing the second memory. The second memory has a larger size of a data erase unit than a size of a data write unit and stores the data. The memory subsystem control circuit writes data on the same tag information in the same management unit and writes data on the different tag information in the different management unit, based on the management information in which n times of the data erase unit (“n” is a natural number) is a management unit.

### TECHNICAL FIELD

The present invention relates to an information processing device suitable for processing large scale data at high speed by using a nonvolatile memory.

### BACKGROUND ART

In response to a recent increase in large scale data, it is desired to use a large capacity nonvolatile memory which can inexpensively store the large scale data with low power consumption. Further, a lot of data needs to be read and written to process large scale data; therefore it is also desired to read and write data at high speed.

On the other hand, in a storage device using a conventional nonvolatile memory, a unit (block) for erasing data is larger than a unit for writing data, and even unnecessary data cannot be overwritten. Therefore, if the block is filled with necessary data and unnecessary data, new data cannot be written. If a writable area is insufficient when new data is written in the storage device from a host, the storage device reads physically scattering necessary data from each block, erases the block from which the data has been read, and writes the read data back to the erased block. Accordingly, an area other than the data written back to the erased block is generally secured as a writable area. This process is called a garbage collection.

Further, PTL 1 discloses, with respect to a storage device using a nonvolatile memory, a technique in which a host notifies the storage device of a file name and an address of file data at a stage when the host erases the file data, the storage device invalidates the data at a stage when the storage device is notified from the host that the file data is erased, and the storage device does not perform a garbage collection and simply erases the file data in the case where a block to be erased only includes the invalidated data.

### CITATION LIST

### Patent Literature

PTL 1: JP 2008-198208 A

### SUMMARY OF INVENTION

### Technical Problem

A storage device using a nonvolatile memory needs a garbage collection, and while the garbage collection is performed, a host needs to stop reading/writing processing. Accordingly, performance of the storage device is degraded, and since the garbage collection also includes writing processing, a lifetime of the storage device having an upper frequency limit of writing is deteriorated.

Further, in the technique disclosed in the above PTL 1, in the case where an erase block includes only invalidated data, the garbage collection is not needed. However, the erase block is not necessarily filled with the invalidated data; therefore, the garbage collection still might be performed, and an issue of the garbage collection is not solved.

An object of the present invention is to accelerate data reading/writing of a storage device using a nonvolatile memory and extend a lifetime of the storage device by eliminating performance of the garbage collection in an inexpensive and large-capacity nonvolatile memory.

### Solution to Problem

An information processing device according to the present invention includes a host and a memory subsystem. The host issues a write command or an erase command with tag information corresponding to data to the memory subsystem and includes an information processing circuit for processing the data. The memory subsystem includes a first memory, a second memory, and a memory subsystem control circuit. The first memory stores management information for managing the second memory. The second memory has a larger size of a data erase unit than a size of a data write unit and stores the data. The memory subsystem control circuit writes data on the same tag information in the same management unit and writes data on the different tag information in the different management unit, based on the management information in which n times of the data erase unit (“n” is a natural number) is a management unit.

Further, in the information processing device according to the present invention, the host includes the information processing circuit which issues a read command with the tag information to the memory subsystem, and the memory subsystem includes the memory subsystem control circuit which reads data corresponding to the same tag information from the second memory and forwards the data to the host.

In the information processing device according to the present invention, the memory subsystem includes the memory subsystem control circuit which erases the data corresponding to the same tag information from the second memory.

In the information processing device according to the present invention, the memory subsystem includes the first memory and the second memory. The first memory is accessible at a higher speed than that of the second memory. The second memory is a nonvolatile memory.

### Advantageous Effects of Invention

According to the present invention, a large scale memory space necessary for analyzing a large scale data can be inexpensively provided by a nonvolatile memory, and also in such a case, performance of a garbage collection in the nonvolatile memory can be eliminated since reading, writing, and erasing are performed at a management unit of n times of an erase unit. Accordingly, data can be read and written at a high speed, and also a lifetime of the nonvolatile memory can be extended.

### BRIEF DESCRIPTION OF DRAWINGS

FIG. 1 illustrates a configuration example of a server (information processing device).

FIG. 2 illustrates a configuration example of a memory subsystem in the server.

FIG. 3 illustrates an example of a configuration of a chip, a block, and a page of a nonvolatile memory in the memory subsystem and an example of a target to be read, written, and erased.

FIG. 4 illustrates an example of a graph of a large scale data to be processed in a server.

FIG. 5 illustrates an example of a sequence of graph analysis processing to be performed in a server.

FIG. 6 illustrates an example of a correspondence relation between a data and a logical address handled by a host.

FIG. 7 illustrates an example of information transmitted from the host to the memory subsystem.

FIG. 8 illustrates an example of a correspondence relation among data belonging to a chip, a block, a super step, and a group of the nonvolatile memory.

FIG. 9 illustrates an example of a data management table.

FIG. 10 illustrates an example of a writing order of a chip, a block, and a page with respect to the nonvolatile memory.

FIG. 11 illustrates an example of a difference in write start chips in different groups.

FIG. 12 illustrates an example of a difference in write start channels in different groups.

FIG. 13 is a flowchart illustrating an example of a data writing process in the server.

FIG. 14 illustrates an example of a state management table of the nonvolatile memory.

FIG. 15 is a flowchart illustrating an example of a data reading process in the server.

FIG. 16 is a flowchart illustrating an example of a data erasing process in the server.

FIG. 17 is a flowchart illustrating an example of data processing in the nonvolatile memory.

FIG. 18 illustrates an example of a table for managing a write data amount of the nonvolatile memory.

FIG. 19 illustrates an example of a correspondence relation between a page and the write data amount of the nonvolatile memory.

### DESCRIPTION OF EMBODIMENTS

An embodiment of a preferable server (information processing device) will be described in detail below with reference to attached drawings.

### A. Configuration of Server

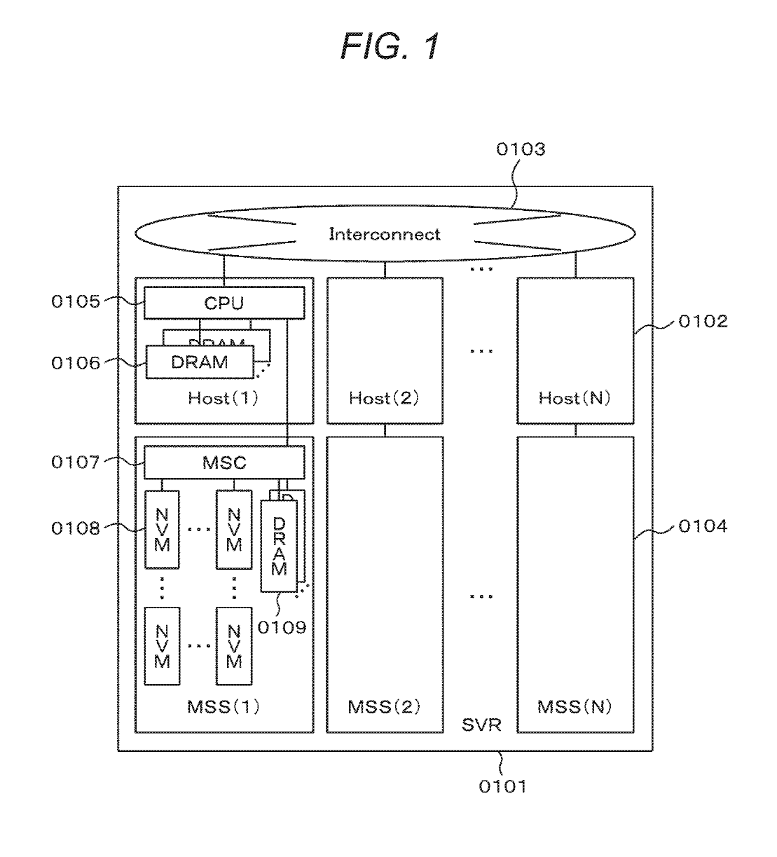

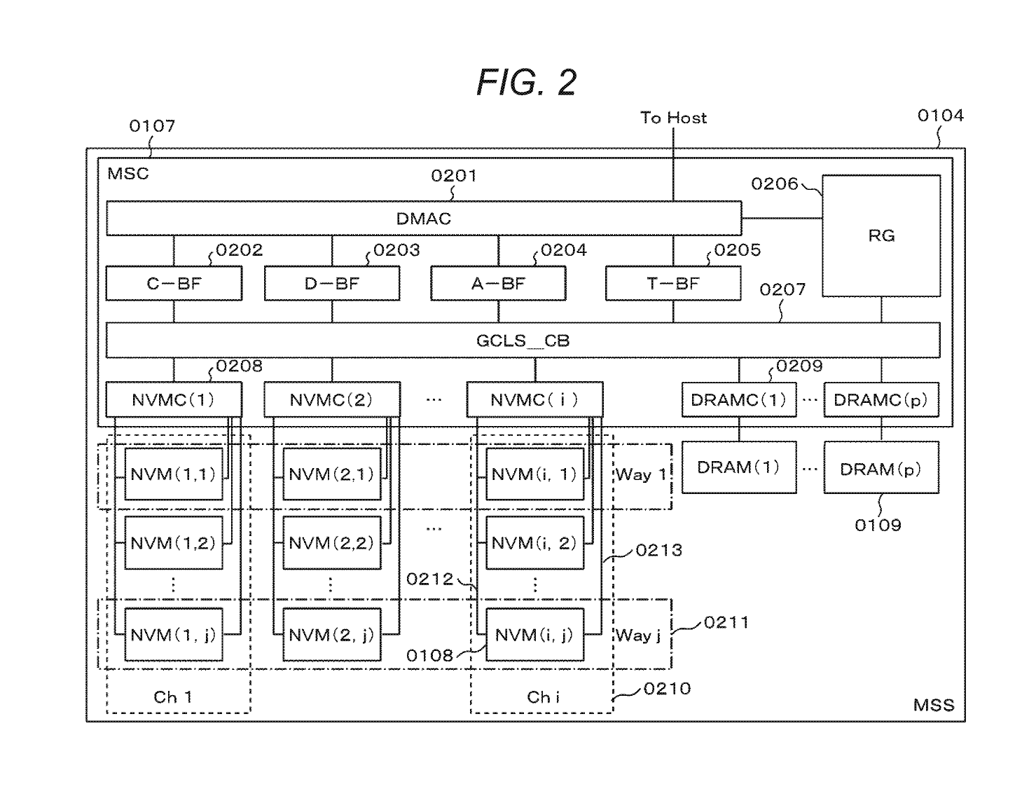

First, a configuration of a server (SVR) 0101 will be described with reference to FIGS. 1 and 2. FIG. 1 illustrates a configuration of the whole of the server 0101 which is an information processing device. The server 0101 includes multiple hosts (Host (1) to Host (N)) 0102, an interconnect (Interconnect) 0103 connecting every hosts 0102, and multiple memory subsystems (MSS (1) to MSS (N)) 0104 connected to each of the hosts 0102.

The host 0102 includes an information processing circuit (CPU) 0105, and one or more memories (DRAM) 0106 connected to the information processing circuit 0105. The information processing circuit 0105 reads information from the memory 0106 and performs a process by writing the information.

Every hosts 0102 can communicate each other via the interconnect 0103. Further, each of the hosts 0102 can communicate with the memory subsystem 0104 connected thereto.

Each of the memory subsystems 0104 includes one memory subsystem control circuit (MSC) 0107, one or more nonvolatile memories (NVM) 0108, and one or more memories (DRAM) 0109. The memory subsystem control circuit 0107 can communicate with the host 0102, the nonvolatile memory 0108, and the memory 0109.

The memory 0109 in the memory subsystem 0104 is a memory for storing management information, and a high speed DRAM is preferably used. However, other than the DRAM, a random access memory may be used, such as an MRAM, a phase change memory, an SRAM, and a NOR flash memory, and a ReRAM. Further, data to be written and data to be read are temporarily stored in the nonvolatile memory 0108 and may be used as a cash of the nonvolatile memory 0108. The nonvolatile memory 0108 stores data written from the host 0102. The nonvolatile memory 0108 is a memory in which a size of a data erase unit of such as a NAND flash memory, a phase change memory, and a ReRAM, which are inexpensive and have a large capacity, is equal to or larger than a size of a data write unit.

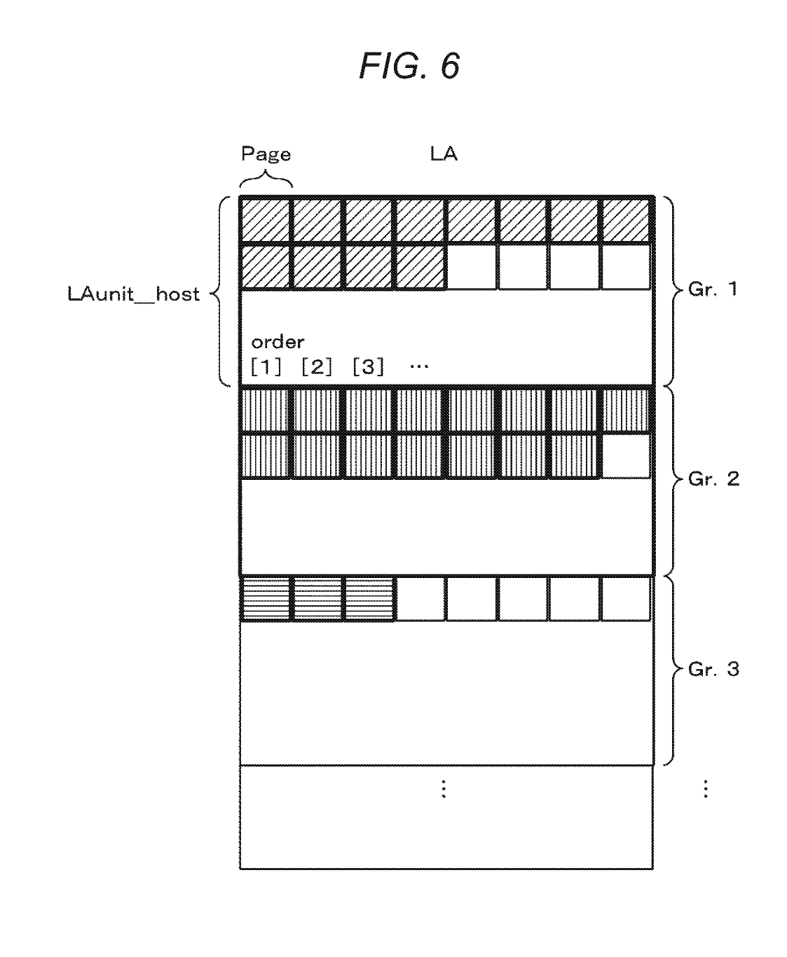

The host 0102 applies a tag number to data to be processed by using the memory subsystem 0104. The memory subsystem control circuit 0107 manages an erase unit of the nonvolatile memory 0108 and writes data, in which the same tag numbers are applied, in the same erase unit of the nonvolatile memory 0108. A sequence of this process will be described later by using FIG. 6. The host 0102 includes a function equivalent to the memory subsystem control circuit 0107, and management of an erase unit and association with a tag number are performed in the host 0102, not in the memory subsystem 0104.

FIG. 2 illustrates the memory subsystem 0104 in further detail.

The memory subsystem 0104 includes one memory subsystem control circuit 0107, the nonvolatile memories (NVM (1, 1) to NVM (i, j)) 0108, and the memories (DRAM (1) to DRAM (p)) 0109 (i, j, and p are natural numbers). The memory subsystem control circuit 0107 includes a memory access control circuit (DMAC) 0201, a command buffer (C-BF) 0202, a data buffer (D-BF) 0203, an address buffer (A-BF) 0204, a tag buffer (T-BF) 0205, a register (RG) 0206, a garbage collection elimination control block (GCLS_CB) 0207, nonvolatile memory control circuits (NVMC (1) to NVMC (i)) 0208, and DRAM control circuits (DRAMC (1) to DRAMC (p)) 0209.

The memory access control circuit 0201 is connected to the host 0102 illustrated in FIG. 1, the command buffer 0202, the data buffer 0203, the address buffer 0204, the tag buffer 0205, and the register 0206 and relays communication between connection destinations. Each of the command buffer 0202, the data buffer 0203, the address buffer 0204, the tag buffer 0205, and the register 0206 is also connected to the garbage collection elimination control block 0207. The command buffer 0202 temporality stores a read command, a write command, and an erase command of data. The data buffer 0203 temporarily stores data to be read/written. The address buffer 0204 temporarily stores an address of data in a read command, a write command, and an erase command from the host 0102. Further, a data size can be temporarily stored.

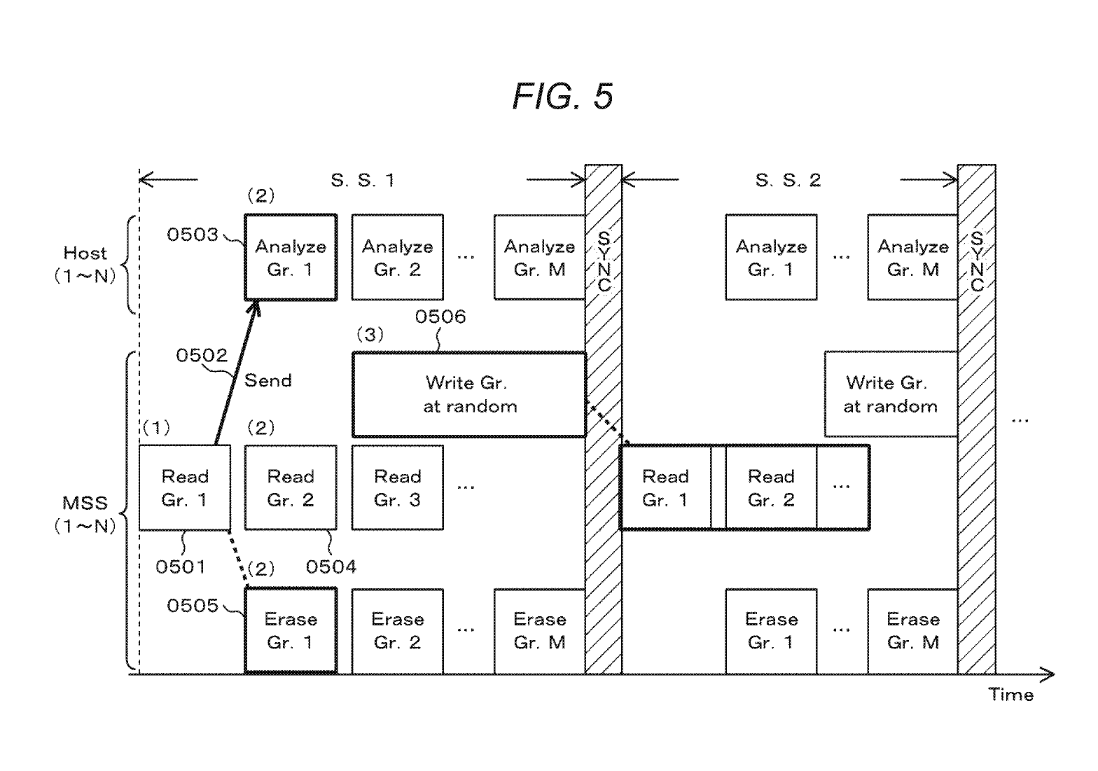

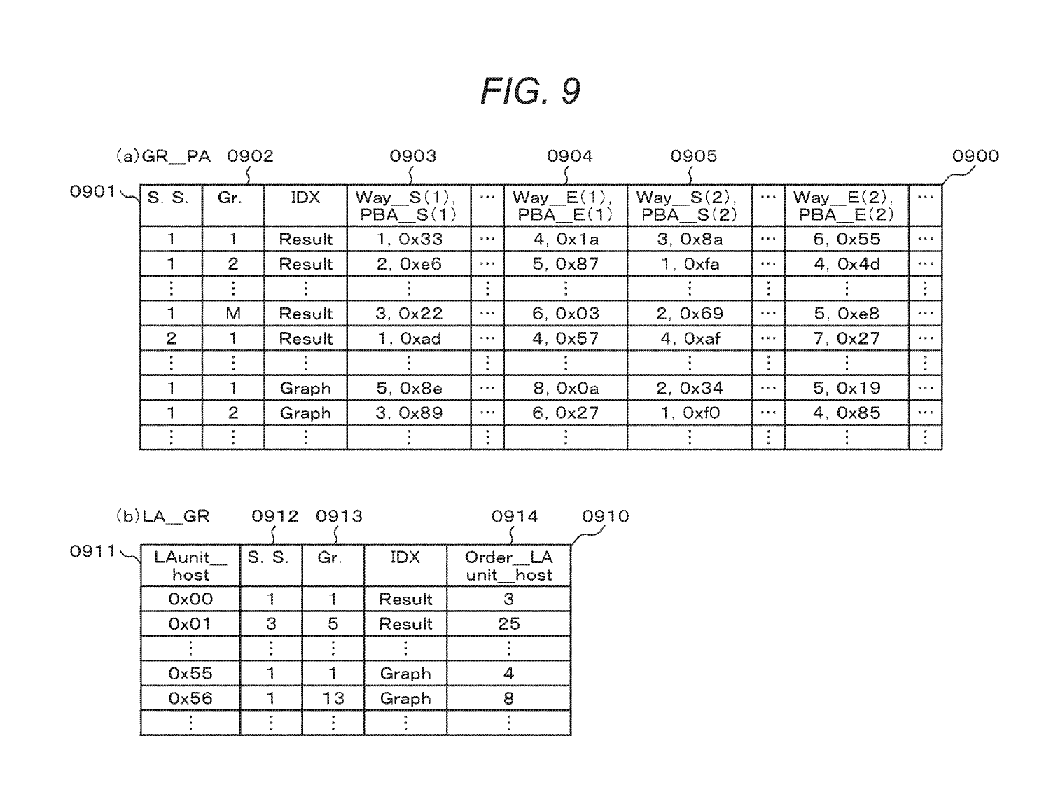

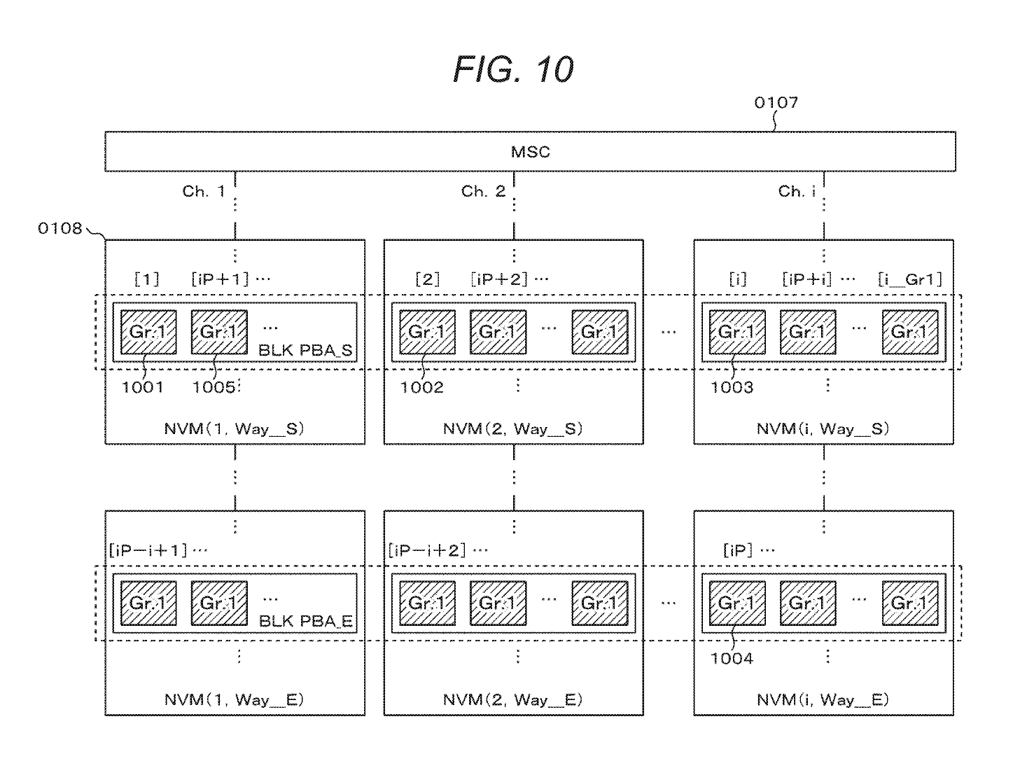

The tag buffer 0205 temporarily stores a tag number, such as a group (Gr.) number, a super step (S.S.) number, a writing order (order) number, and a data type identifier (IDX), of data in a read command, a write command, and an erase commend from the host 0102. The group and the super step will be described later with reference to FIG. 5. The writing order will be described later with reference to FIGS. 6 and 10. The data type identifier will be descried later with reference to such as FIG. 9. However, the tag number is not limited to these numbers and may be other than these numbers. Further, the writing order number may not be stored. The tag number is the same number in every data in an erase unit of the nonvolatile memory 0108. Data corresponding to a different tag number is stored in a different erase unit of the nonvolatile memory 0108. In such a tag number, the tag number may include a writing order and a physical address of the nonvolatile memory 0108, a standard in which the tag numbers are the same may not be related to a writing order and a physical address, and an erase unit of the nonvolatile memory 0108 may be the same.

The register 0206 stores control information necessary for a process of the garbage collection elimination control block 0207 set by the host 0102 and enables to read the information from the garbage collection elimination control block 0207.

The garbage collection elimination control block 0207 communicate with the register 0206, the command buffer 0202, the data buffer 0203, the address buffer 0204, and the tag buffer 0205 and controls the nonvolatile memory control circuit 0208 and the DRAM control circuit 0209.

The nonvolatile memory control circuits (NVMC (1) to NVMC (i)) 0208 are connected to the nonvolatile memories (NVM (i, 1) to NVM (i, j)) 0108 and reads, writes, and erases data in the connected nonvolatile memories 0108. Here, “i” is a natural number of 1 to i and indicates a channel number. Multiple channels 0210 include a data transfer bus (I/O) 0212 which can independently communicate. The data transfer bus 0212 is shared among j nonvolatile memories (NVM (i, 1), NVM (i, 2), . . . , NVM (i, j)) 0108 belonging to one channel i (Ch i) 0210. Further, j nonvolatile memories 0108 belonging to each channel are independent memories and can independently process a command from the nonvolatile memory control circuit 0208. In an order physically close to the nonvolatile memory control circuit 0208, j nonvolatile memories 0108 belong to ways (Way 1, Way 2, . . . , Way j) 0211. The nonvolatile memory control circuit 0208 can determine whether each nonvolatile memory 0108 is processing data, by reading a signal of a ready/busy line (RY/BY) 0213 connected to each nonvolatile memory 0108. The nonvolatile memory control circuit 0208 is connected to the garbage collection elimination control block 0207 and can communicate with each other.

The DRAM control circuits (DRAMC (1) to DRAMC (p)) 0209 are respectively connected to the memories (DRAM (1) to DRAM (p)) 0109 and read data from the memories 0109 and write data in the memories 0109. Further, the DRAM control circuit 0209 is connected to the garbage collection elimination control block 0207 and can communicate with each other.

### B. Configuration of Nonvolatile Memory and Reading, Writing, and Erasing Processes

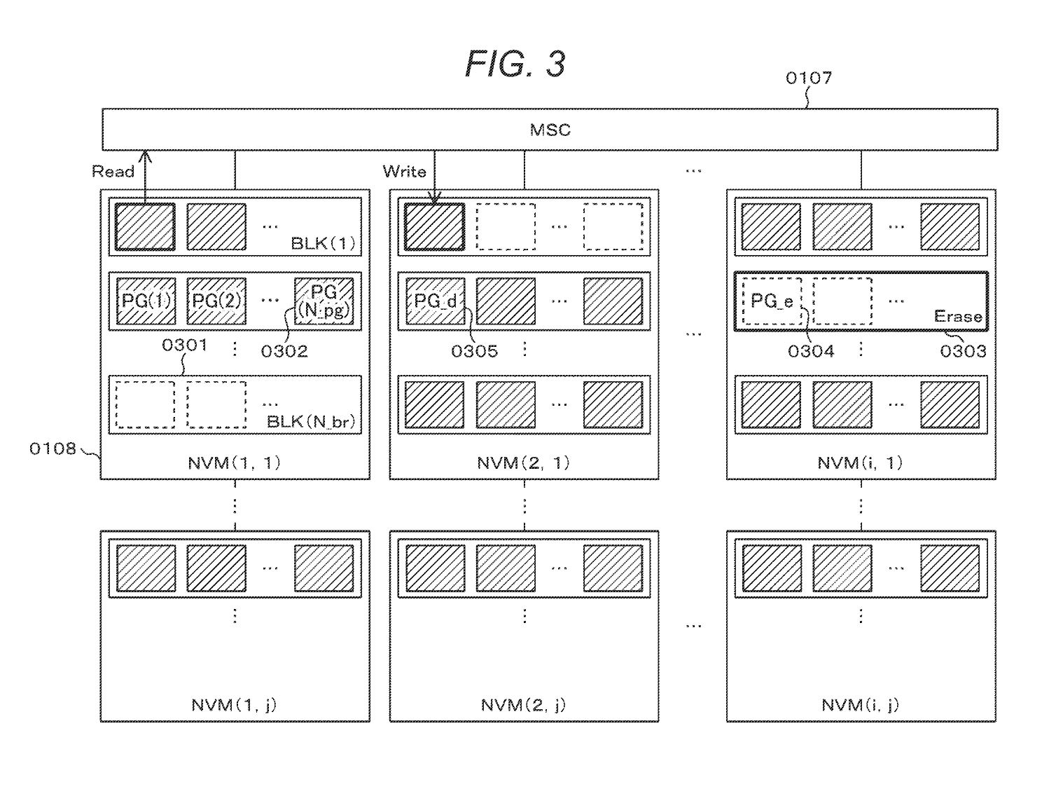

With reference to FIG. 3, a configuration in the nonvolatile memory 0108 and reading, writing, and erasing processes of data will be described next. Each of the nonvolatile memories 0108 includes N_br blocks (BLK) 0301. Each of the blocks 0301 include N_pg pages (PG) 0302. Here, “N_br” and “N_pg” are natural numbers. For example, a data size of one block 0301 in a NAND flash memory, which is the nonvolatile memory 0108, having a capacity of 8 GB/chip is 1 MB. When a data size of one page 0302 is 8 kB, the following formulas are established, N_br=8 k=(8 GB/1 MB) and N_pg=128=(1 MB/8 kB).

Data stored in the nonvolatile memory 0108 is read at a unit of the page 0302, and the data is written in the nonvolatile memory 0108 at a unit of the page 0302. Data stored in the nonvolatile memory 0108 is erased at a unit of the block 0301. When data is written in the nonvolatile memory 0108, the data cannot be overwritten. Therefore, for example, data can be written in a page (PG_e) 0304 in a block 0303 erased as illustrated in FIG. 3. However, new data cannot be written in a page (PG_d) 0305 in which data is already written. In summary, the nonvolatile memory 0108 has two characteristics as follows.

Characteristic 1: A data size of an erase unit (the block 0301) is equal to or larger than a data size of a write unit (the page 0302).

Characteristic 2: New data cannot be overwritten in such as the page 0305 in which data is already written.

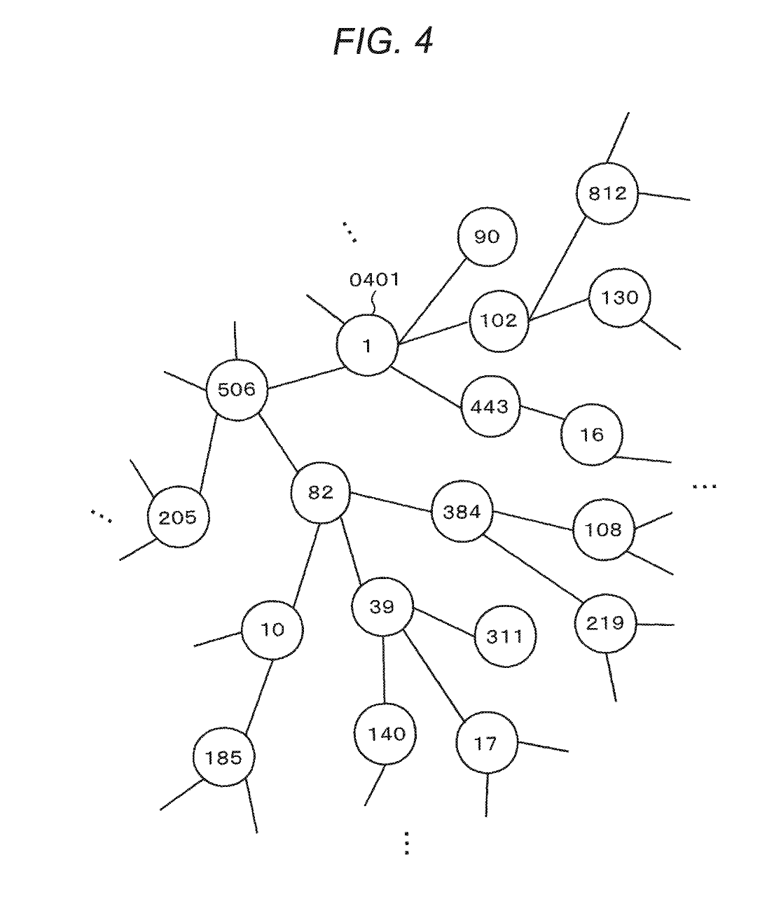

A process of the server 0101 will be described below by exemplifying a large scale graph analysis. First, an example of a graph handled in the server 0101 and an example of an analysis sequence of data of the graph will be described with reference to FIGS. 4 and 5.

### C. Graph and Graph Analysis Sequence

FIG. 4 illustrates an example of a graph handled in the server 0101. In a graph exemplified herein, a vertex number for uniquely specifying each vertex is allocated to a vertex 0401 of the graph. One side of the graph, which connects two vertices, indicates that the two vertices are related. Each vertex 0401 of the graph becomes graph data of an analysis target. Generally, since a huge number of the vertices 0401 of a graph are targeted for a graph analysis, the multiple vertices 0401 are classified into groups in accordance with allocated vertex numbers, and the vertices 0401, specifically graph data, in each group are analyzed.

FIG. 5 illustrates a sequence of a graph analysis in the server 0101. Graph data (Graph) and a graph analysis result (Result) are stored in the nonvolatile memory 0108 in the memory subsystem 0107. The graph data and the graph analysis result are classified into groups and processed by reading/writing. A sequence below is simultaneously and parallelly performed in N hosts 0102 and the memory subsystem 0104.

Time 1: First, the memory subsystem 0104 reads graph data of a group 1 stored in the nonvolatile memory 0108 (Read Gr. 1) 0501 and sends the data to the host 0102 (Send) 0502.

Time 2: Next, the host 0102 analyzes the graph data in the group 1 sent from the memory subsystem 0104 (Analyze Gr. 1) 0503. In parallel with this, the memory subsystem 0104 reads graph data of a group 2 to be analyzed in the host 0102 next (0504). In parallel with these, the memory subsystem 0104 erases the graph data of the group 1 (0505). The graph data of the group 1 can be erased at this timing since the data is not used again after analysis by the host.

Time 3: Each host 0102 transmits a graph analysis result of the group 1 to other hosts 0102. Each of the hosts 0102 classifies graph analysis results sent from the other hosts 0102 into each group and sends the results to the memory subsystem 0104. The memory subsystem 0104 writes the graph analysis result, which has been sent from the host 0102 and classified for each group, in the nonvolatile memory 0108 (Write Gr. at random) 0506. Specifically, the host 0102 sends data for each page 0302 which is a write unit of the nonvolatile memory 0108 to the memory subsystem 0104 in a random order of group numbers.

The above-described sequence is repeated in the group order. After every groups 1 to M finish processing, synchronization is performed among the host (Host (1) to Host (N)) 0102 for confirming process completion (SYNC). This sequence of the processes and the synchronization of the groups 1 to M are called a super step (S.S.), and the processes are repeated in an order from the group 1 after the synchronization. A graph analysis result written in the memory subsystem 0104 in the previous super step is read in the next super step as graph data. The graph analysis is performed by repeating this super step.

### D. Communication Between Host and Memory Subsystem

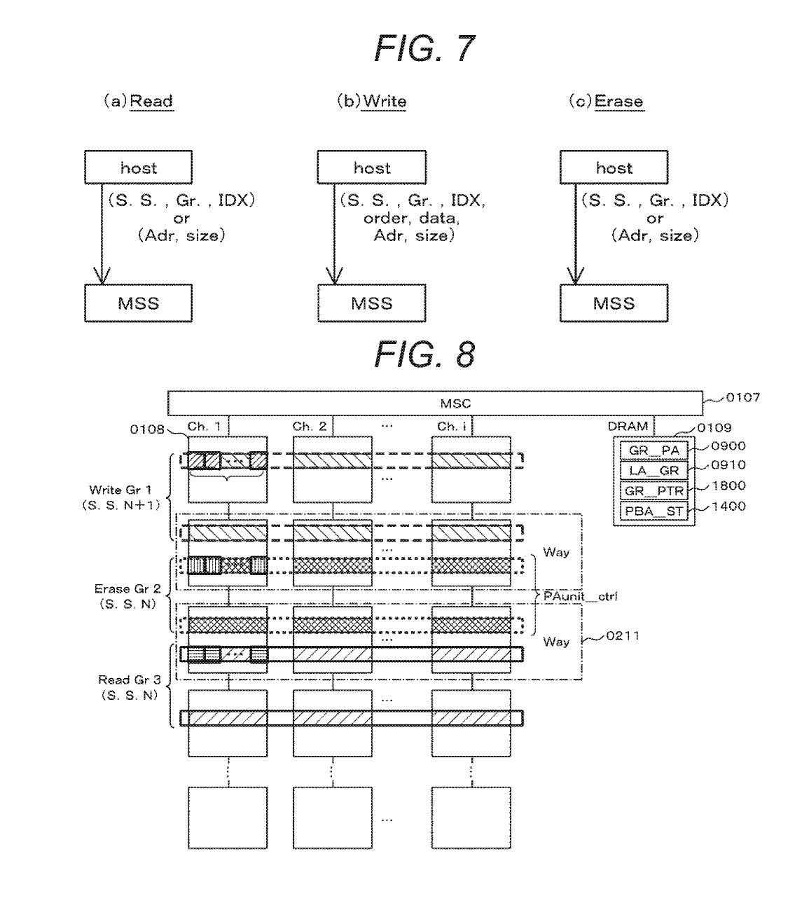

With reference to FIGS. 6 and 7, communication between the host 0102 and the memory subsystem 0104 will be described. As illustrated in FIG. 6, the host 0102 manages data stored in the memory subsystem 0104 by a logical address (LA). In a graph analysis, the host 0102 writes data for each page 0302, which is a write unit of the nonvolatile memory 0108, in the memory subsystem 0104 in a random order of group numbers. In such a case, a write destination logical address of each group data is managed in a management unit (LAunit_host) determined for each group by the host 0102. The host 0102 fills a logical address of each LAunit_host from the beginning in an order in which data of each group is sent to the memory subsystem 0104, and manages the data by sequencing in a write order (order) at a unit of the page 0302 for each group.

FIG. 7 illustrates information sent to the memory subsystem 0104 when the host 0102 sends a read command, a write command, and an erase command to the memory subsystem 0104.

### (a) Read

When the host 0102 issues a read command of data in the memory subsystem 0104 (Read), the host 0102 sends, to the memory subsystem 0104, a super step (S.S.) number, a group (Gr.) number, and a data type identifier (IDX) of the data to be read. Alternatively, the host 0102 sends a logical address (Adr) and a read data size (size) to the memory subsystem 0104. The data type identifier is additional information to be used when the memory subsystem 0104 classifies various graph data, classifies graph data and graph analysis results, and classifies vertex numbers. The memory subsystem 0104 reads data based on the above information sent from the host 0102 and returns the read data to the host 0102.

### (b) Write

When the host 0102 issues a data write command to the memory subsystem 0104 (Write), the host 0102 sends, to the memory subsystem 0104, a super step (S.S.) number, a group (Gr.) number, and a data type identifier (IDX) of write data, and a write order (order) and write data (data) in a group, and as necessary, a logical address (Adr) and a write data size (size). The memory subsystem 0104 writes data in the nonvolatile memory 0108 based on the above information sent from the host 0102. A write order in a group is not necessarily included in a tag number.

### (c) Erase

When the host 0102 issues an erase command of data in the memory subsystem 0104 (Erase), the host 0102 sends, to the memory subsystem 0104, a super step (S.S.) number, a group (Gr.) number, and a data type identifier (IDX) of data to be erased. Alternatively, the host 0102 sends a logical address (Adr) and a size of data to be erased (size) to the memory subsystem 0104. The memory subsystem 0104 erases data based on the above information sent from the host 0102.

### E. Data Management Method in Memory Subsystem

With reference to FIGS. 8 to 12, a data management method in the memory subsystem 0104 will be described. As illustrated in FIG. 8, the memory subsystem control circuit 0107 allocates data for each super step number and group number to a management unit (PAunit_ctrl) configured from the blocks 0301 of the multiple nonvolatile memories 0108 and stores the data in the register 0206. In an example of FIG. 8, each block of 2i nonvolatile memories 0108 belonging to channels (Ch. 1 to i) and two ways 0211 is collected as one PAunit_ctrl, and data of the same super step and the same group is stored in the same PAunit_ctrl. Data of a different super step or a different group is stored in a different PAunit_ctrl and processed in parallel in accordance with the sequence illustrated in FIG. 5. Although one PAunit_ctrl includes two ways 0211 in FIG. 8, three ways may be included. Since a different channel 0210 is connected to a different nonvolatile memory 0108 by a different data transfer bus 0212, multiple nonvolatile memories 0108 can be simultaneously operated, and although a different way 0211 also uses the data transfer bus 0212, a different nonvolatile memory 0108 can be simultaneously operated, and accordingly a high speed data transfer can be realized. Further, even if one PAunit_ctrl is erased, the block 0301 in a different super step or a different group is not affected. Therefore, a garbage collection is not needed, and a high speed data transfer can be realized. A high speed graph analysis can be realized by the high speed data transfer.

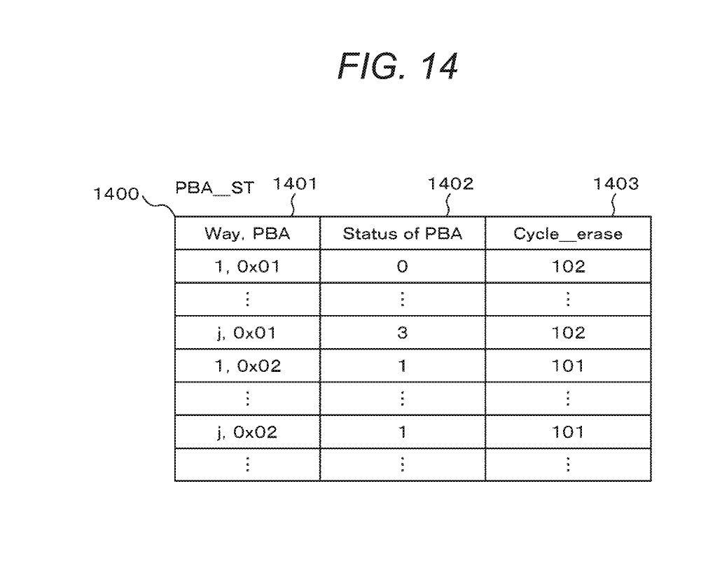

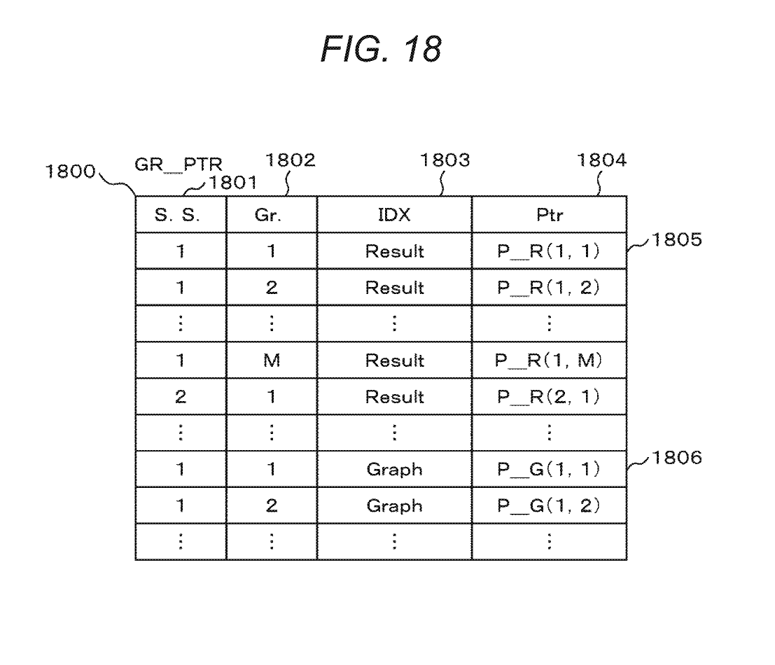

A table (GR_PA) 0900, a table (LA_GR) 0910, a table (GR_PTR) 1800, and a table (PBA_ST) 1400, which are stored in the memory 0109, are used for managing by LAunit_host and PAunit_ctrl. First, the table (GR_PA) 0900 and the table (LA_GR) 0910 will be described, and the table (GR_PTR) 1800 and the table (PBA_ST) 1400 will be described later with reference to FIGS. 18 and 14 respectively.

Association of a super step number and a group number of data and numbers of a way and a block in which data is stored is managed by the table (GR_PA) 0900 illustrated in FIG. 9(a). Further, association of a logical address and each super step number and group number is managed by the table (LA_GR) 0910 illustrated in FIG. 9(b). One each of the tables 0900 and 0910 may be prepared in accordance with graph data and a graph analysis result, specifically contents of a data type identifier.

If a super step number, a group number, and a data type identifier (IDX) are provided, the memory subsystem control circuit 0107 can identify, by using the table (GR_PA) 0900, a first way (Way_S) of the nonvolatile memory 0108 including the PAunit_ctrl in which corresponding data is stored, a last way (Way_E) from a first block number (PBA_S) 0903 in the way (Way_S), and a last block number (PBA_E) 0904 in the way (Way_E). In the case where, in FIG. 9(a), a super step number is 1, a group number is 1, and a data type identifier is a graph analysis result, the first way (Way_S) is 1, and in the case where the way (Way_S) is 1, the first block number (PBA_S) is 0x33 (33 in hexadecimal). In the case where data corresponding to one super step, group, and data type identifier is not stored in one PAunit_ctrl and is stored in a plurality of the PAunit_ctrl, a way number and a block number of each PAunit_ctrl are sequentially stored in the table (GR_PA) 0900, and a beginning of the PAunit_ctrl next to the way (Way_S(1)) 0903 is such as a way (Way_S(2)) 0905. Specifically, each of ways (Way_S(1) to Way_E(1)) and ways (Way_S(2) to Way_E(2)) corresponds to one PAunit_ctrl.

Further, if a logical address of data is provided, the memory subsystem control circuit 0107 can determine a super step number, a group number, and a data type identifier, to which data belong, by using the table (LA_GR) 0910. An entry (LAunit_host) in the table (LA_GR) 0910 is a number of the LAunit_host which is a management unit of a logical address by a host. A super step number and a group number of data corresponding to data of the logical address is indicated by a value of an Order_LA_host.

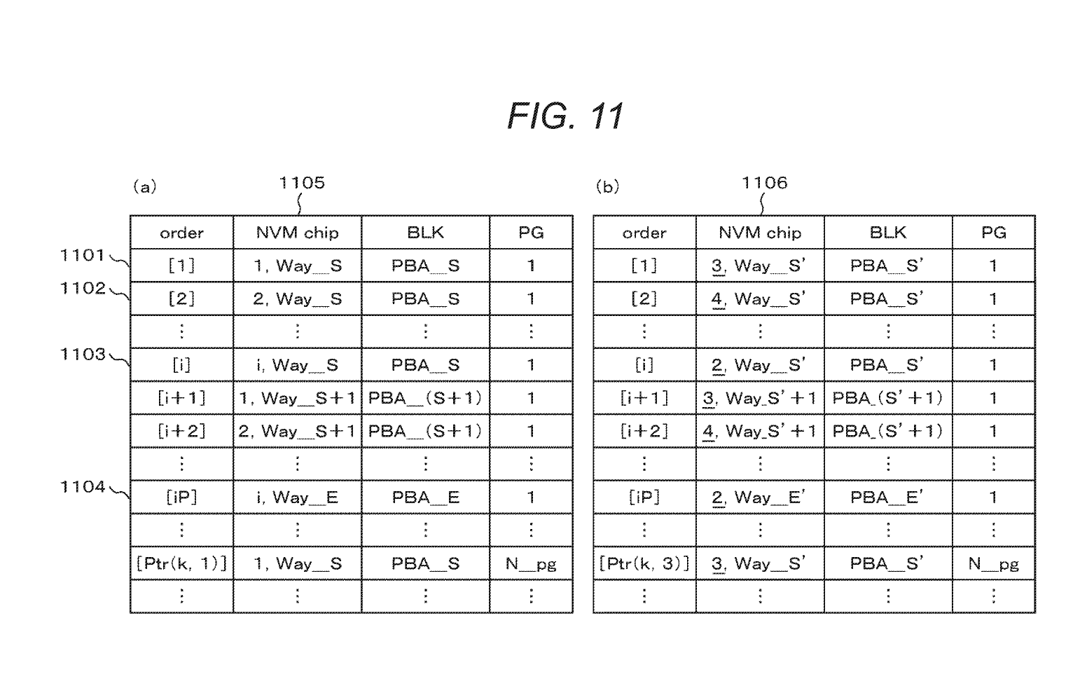

Next, a data layout in the PAunit_ctrl of the memory subsystem control circuit 0107 will be described with reference to FIGS. 10 to 12. First, a data layout in the case where a super step number is k, and a group number is 1 will be exemplified. The memory subsystem control circuit 0107 writes data by distributing the nonvolatile memory 0108 for each page 0302 in a write order (order) from the host 0102. As illustrated in FIG. 11(a), data of order=[1] 1101 is stored in a page 1001, illustrated in FIG. 10, in which a page (PG) number of a block (BLK) number PBA_S of the nonvolatile memory (1, Way_S) 0108 is 1, and the data of order=[2] 1102 is stored in a page 1002 of the same block number (PBA_S) and the same page number (1) of the nonvolatile memory (2, Way_S) belonging to a next channel (Ch. 2).

Similarly, data of order=[i] 1103 is stored in a page 1003 of the same page number (1) of the same block number (PBA_S) in the nonvolatile memory (i, Way_S). The next data of order=[i+1] is stored in a block number (PBA_(S+1)) of the next way (Way_S+1) and the same page number (1). Data by order=[iP] is sequentially stored in the same page number of each block of nonvolatile memories (1104, 1004). However, iP indicates a number of the nonvolatile memory 0108 allocated to one PAunit_ctrl, and the following formula is established: iP=i×(Way_E−Way_S+1). After order=[iP], data is stored in the same order as order=[1] to [iP] in such as a page 1005 which is a page number next to each nonvolatile memory 0108. Since data is stored as regulated above, a page number can be calculated.

The data in which a group number is 1 have been described above. In this case, data of order=[1] is stored in the nonvolatile memory 0108 in the channel (Ch. 1). However, data of a different group number is disposed so as to differentiate a channel number of the nonvolatile memory 0108 in which the data of order=[1] is to be written. For example, in the case where data in which a group number is 3 is stored, data of order=[1] is written from the nonvolatile memory (3, Way_S′) of a channel (Ch. 3) as indicated in an NVM chip 1106 as in FIG. 11(b) with respect to an NVM chip 1105 illustrated in FIG. 11(a). Subsequent data order=[2], [3], . . . will be sequentially stored in an order of channels (ch. 4, 5, . . . ).

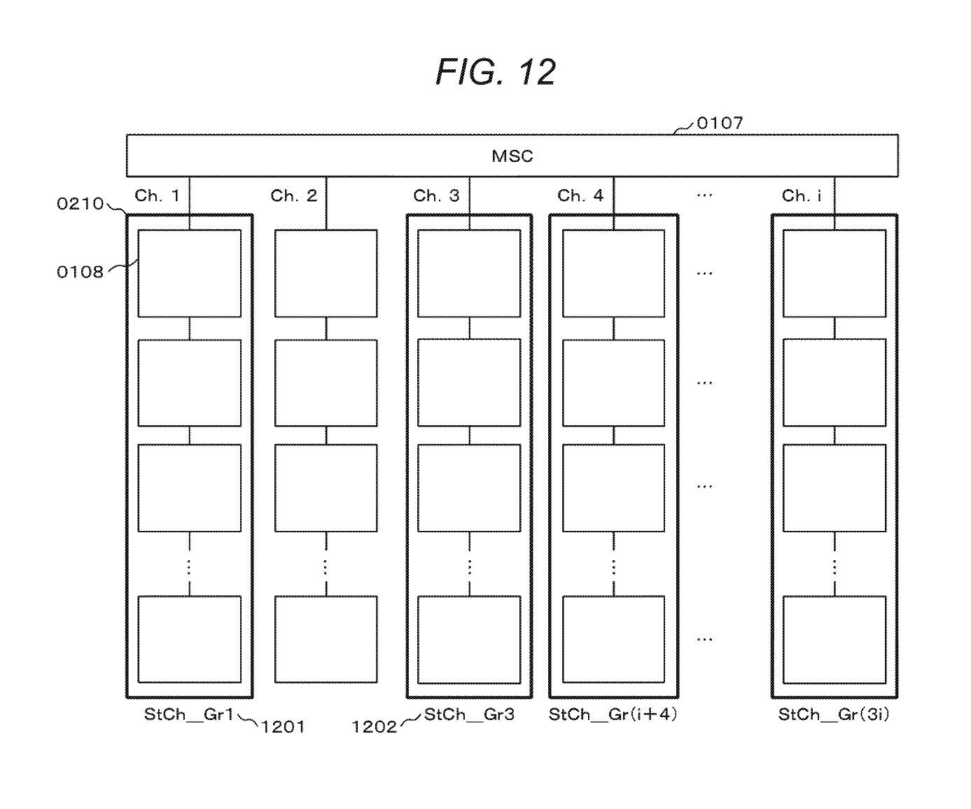

Generally, as illustrated in FIG. 12, data of order=[1] is stored in the nonvolatile memory 0108, and the number of the channel (Ch.) 0210 to which the nonvolatile memory 0108 belongs is denoted by StCh_GrA. This value is determined by the formula, StCh_GrA=A % i+1 (A is a remainder when divided by the quantity i of the channel 0210+1). In the case where a group number is 1, the channel number becomes StCh_Gr1 1201. In the case where the group number is 3, the channel number becomes StCh_Gr3 1202. Here, regarding data of a different group number, ways (Way_S and Way_S′) and blocks (PBA_S and PBA_S′) are not necessarily different. Since data is stored as regulated above, a channel number can be calculated.

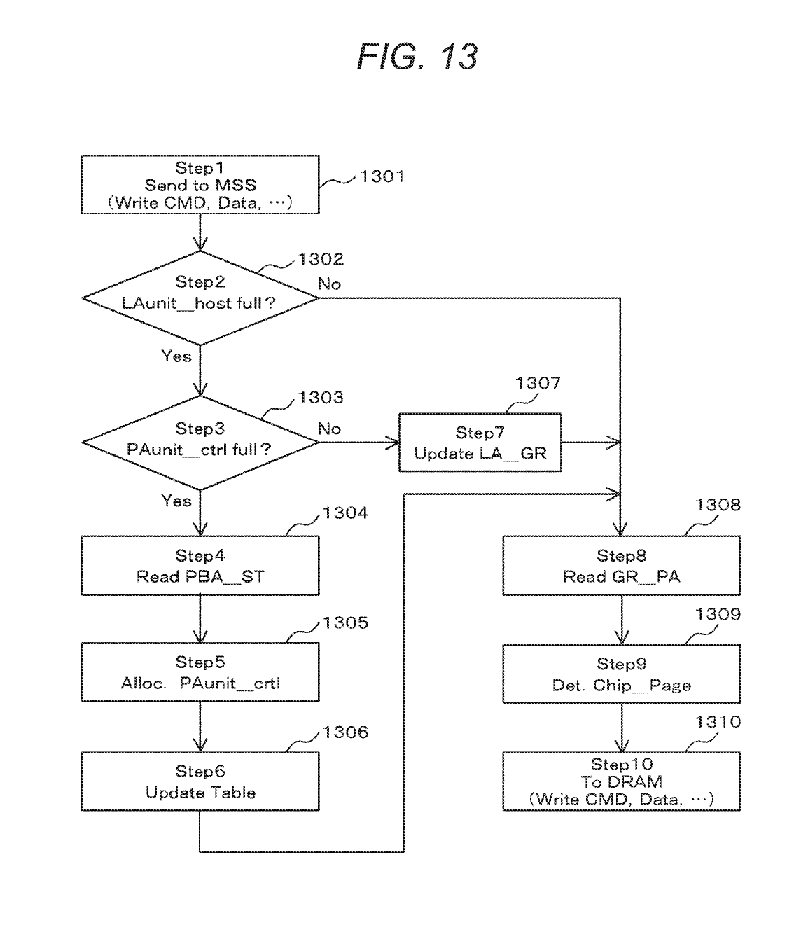

In the case where the server 0101 performs graph processing, processing of the memory subsystem 0104 will be described with reference to FIGS. 13 to 19.

### F. Processing by Memory Subsystem Control Circuit in Graph Analysis

(1) The host 0102 which performs an input graph analysis of data necessary for control of a memory subsystem writes data necessary for control of the memory subsystem 0104 in the register 0206 of the memory subsystem 0104 before the graph analysis. The data necessary for control of the memory subsystem 0104 includes the LAunit_host which is a management unit of a logical address by the host 0102, the number of a super step and a group, a graph data size, an identifier of a graph data (necessary for differentiate a graph), and the quantity of vertices and sizes of a graph. In the case of searching the shortest route of a graph, two vertices desired to search the shortest route, specifically information for specifying a starting point and an ending point, are included.

(2) Data Writing Process

Processing of the memory subsystem control circuit 0107 in data writing will be described based on FIGS. 13 and 14.

FIG. 13 is a flowchart of a writing process. The memory access control circuit 0201 in the memory subsystem control circuit 0107 forwards, to the memory subsystem 0104, a data write command stored in the memory 0106 managed by the host 0102, a super step number, a group number, and a data type identifier of write data, and a writing order in a group. As necessary, together with the above, write data, a logical address of the write data, and a size of the write data are forwarded. Next, the memory access control circuit 0201 stores a write command in the command buffer 0202 and stores, in the tag buffer 0205, a super step number, a group number, a data type identifier, and a write order number in a group. The write order number may be stored in a buffer other than the tag buffer 0205. The memory access control circuit 0201, as necessary, stores write data in the data buffer 0203 and stores a logical address of the write data and a size of the write data in the address buffer 0204 (Step 1 (Send to MSS) 1301).

Next, the garbage collection elimination control block 0207 reads a write order number in a group from the buffer and reads, from the register 0206, the LAunit_host which is a management unit of a logical address determined by the host 0102. As this result, in the case where the logical address LA of data to be written next is a beginning of the LAunit_host which is a management unit of the logical address LA determined by the host 0102 (Step 2 (LAunit_host full) 1302 is Yes), Step 3 1303 is performed. On the other hand, in the case where a logical address of data to be written next is not a beginning of the LAunit_host (Step 2 (LAunit_host full) 1302 is No), Step 8 1308 is performed. For example, if a page data size is 8 kB, and the LAunit_host is 1 MB, the formula, 1 MB/8 kB=128, is established, and if the formula, order=[128×n+1] (“n” is a natural number), is established, LAunit_host full in Step 2 1302 becomes Yes, and it becomes No in other cases.

Next, in Step 3 1303, the garbage collection elimination control block 0207 reads a write order number in a group from a buffer and reads, from the register 0206, the PAunit_ctrl which is a management unit of a physical address determined by the garbage collection elimination control block 0207. As this result, if data to be written next is a beginning of the PAunit_ctrl (Step 3 (PAunit_ctrl full) 1303 is Yes), Step 4 1304 is performed. On the other hand, if the data to be written next is not a beginning of the PAunit_ctrl (Step 3 (PAunit_ctrl full) 1303 is No), Step 7 1307 is performed. For example, if a page data size is 8 kB, and the PAunit_ctrl is 32 MB, the formula, 32 MB/8 kB=4096, is established, and if the formula, order=[4096×n+1] (“n” is a natural number), is established, the PAunit_ctrl full in Step 3 1303 becomes Yes, and it becomes No in other cases.

Next, the garbage collection elimination control block 0207 sends a read command to the DRAM control circuit 0209 and reads the table (PBA_ST) 1400 stored in the memory 0109 (Step 4 (Read PBA_ST) 1304). As illustrated in FIG. 14, the table (PBA_ST) 1400 records a physical block status (Status of PBA) 1402 with respect to each way and block (Way, PBA) 1401 and records an erase frequency (Cycle erase) 1403. The physical block status (Status of PBA) 1402 records “0: unavailable (defective block)”, “1: data is erased”, 2: no data read by a host (before reading)”, “3: data read by the host is stored (during reading)”, “4: no unread data (reading is completed)”, and “5: secured as a data write destination”.

The garbage collection elimination control block 0207 refers to a physical block status (Status of PBA) 1402 of the table (PBA_ST) 1400 and allocates a block, in which data is erased, to anew PAunit_ctrl (Step 5 (Alloc.PAunit_ctrl) 1305).

After Step 5 1305, the garbage collection elimination control block 0207 issues a data write command to the DRAM control circuit 0209 and updates the physical block status (Status of PBA) 1402 of the table (PBA_ST) 1400 stored in the memory 0109, and the newly allocated physical block is set to “5: secured as a data write destination”. Further, the garbage collection elimination control block 0207 similarly issues a data write command to the DRAM control circuit 0209, updates the table (GR_PA) 0900 illustrated in FIG. 9(a), and records the PAunit_ctrl newly secured in Step 5 1305. Further, if a logical address of write data is stored in the address buffer 0204, the table (LA_GR) 0910 illustrated in FIG. 9 (b) is updated (Step 6 (Updatetable) 1306).

In Step 7 1307, in the case where a logical address of write data is stored in an address buffer, the garbage collection elimination control block 0207 issues a data write command to the DRAM control circuit 0209 and updates the table (LA_GR) 0910 illustrated in FIG. 9 (b) and stored in the memory 0109.

Next, the garbage collection elimination control block 0207 sends a read command to the DRAM control circuit 0209 and reads the table (GR_PA) 0900 stored in the memory 0109 (Step 8 (Read GR_PA) 1308).

After Step 8 1308, the garbage collection elimination control block 0207 reads a super step number, a group number, and a data type identifier from the tag buffer 0205 and reads a write order number in a group from a buffer. Further, the garbage collection elimination control block 0207 refers to the table (GR_PA) 0900 read in Step 8 1308 and determines a way, a block and a page of a nonvolatile memory which is a data write destination (Step 9 (Det. Chip_Page) 1309). At the end, the garbage collection elimination control block 0207 issues a data write command to the DRAM control circuit 0209, forwards the data write command from the host 0102 to the memory 0109 from the command buffer 0202, forwards a super step number, a group number, and a data type identifier to the memory 0109 from the tag buffer 0205, and forwards a write order (order) in a group to the memory 0109 from the buffer 05. Together with these, the garbage collection elimination control block 0207 forwards a way, a block, and a page of the nonvolatile memory 0108, which is a data write destination, to the memory 0109. Further, as necessary, the garbage collection elimination control block 0207 forwards write data from the data buffer 0203 to the memory 0109 and forwards a logical address of write data and a write data size from an address buffer to the memory 0109 (Step 10 (To DRAM) 1310).

(3) Data Reading Process

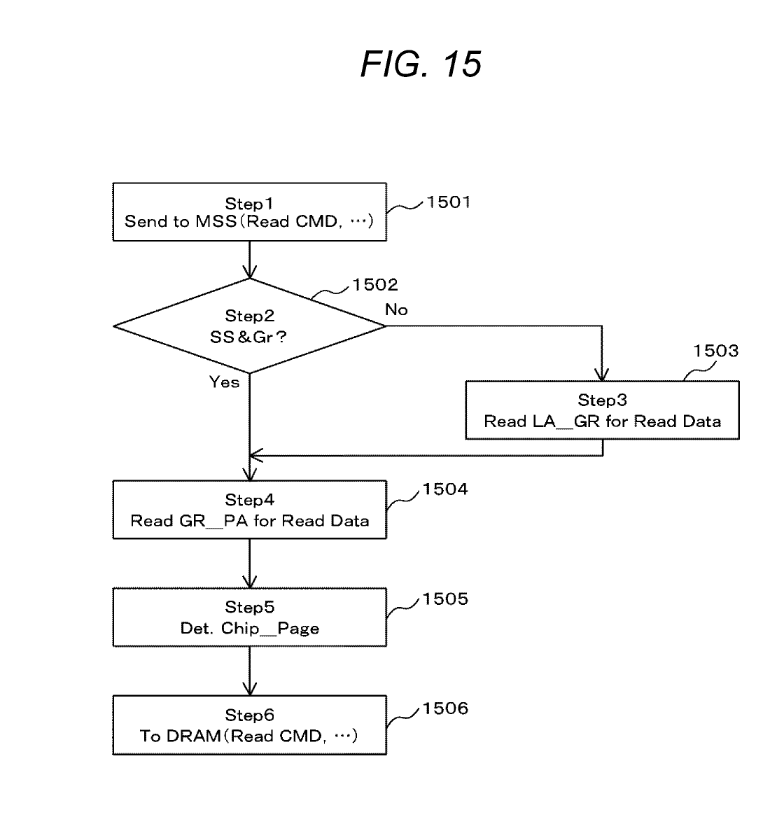

Processing of the memory subsystem control circuit 0207 in data reading will be described based on FIG. 15.

The memory access control circuit 0201 in the memory subsystem control circuit 0107 forwards, to the memory subsystem 0104, a data read command stored in the memory 0106 managed by the host 0102, a super step number, a group number, and a data type identifier of read data. Next, the memory access control circuit 0201 stores a read command in the command buffer 0202 and stores a super step number, a group number, and a data type identifier in the tag buffer 0205 (Step 1 (Send to MSS) 1501). Alternatively, first, the memory access control circuit 0201 forwards, to the memory subsystem 0104, a data read command stored in the memory 0106 managed by the host 0102 and a logical address and a data size of read data. Then, the logical address of the read data and a size of the read data are stored in the address buffer 0204 (Step 1 (Send to MSS) 1501).

Next, the garbage collection elimination control block 0207 refers to a tag buffer and confirms whether a super step number, a group number, and a data type identifier of the read data are forwarded from the host 0102 (Step 2 (SS&GR?) 1502). Consequently, if these are stored in the tag buffer 0205, Step 4 1504 is performed (Step 2 1502 is Yes). If not, Step 3 1503 is performed (Step 2 1502 is No).

In Step 3 1503, the garbage collection elimination control block 0207 reads a logical address of read data and a size of the read data from the address buffer 0204. After that, the garbage collection elimination control block 0207 issues a data read command to the DRAM control circuit 0209, reads the table (LA_GR) 0910 illustrated in FIG. 9 (b) from the memory 0109 (Step 3 (Read LA_GR for Read Data) 1503), specifies a super step number, a group number, and a data type identifier of read data based on the table (LA_GR) 0910, and stores them in the tag buffer 0205.

Next, the garbage collection elimination control block 0207 issues a data read command to the DRAM control circuit 0209 and reads the table (GR_PA) 0900 illustrated in FIG. 9 (a) from the memory 0109 (Step 4 (Read GR_PA for ReadData) 1504).

The garbage collection elimination control block 0207 reads a super step number, a group number, and a data type identifier from the tag buffer 0205. Then, the garbage collection elimination control block 0207 refers to the table (GR_PA) 0900 read in Step 4 1504 and determines a way, a block and a page of a nonvolatile memory which is a data read destination (Step 5 (Det. Chip_Page) 1505).

At the end, the garbage collection elimination control block 0207 issues a data write command to the DRAM control circuit 0209, forwards the data read command from the host 0102 to the memory 0109 from a command buffer, forwards a super step number, a group number, and a data type identifier to the memory 0109 from the tag buffer 0205. Together with these, the garbage collection elimination control block 0207 forwards a way, a block, and a page of the nonvolatile memory 0108, which is a data read destination, to the memory 0109. Further, as necessary, the garbage collection elimination control block 0207 forwards a logical address and a data size of read data from the address buffer 0204 to the memory 0109 (Step 6 (To DRAM) 1506).

(4) Data Erasing Process

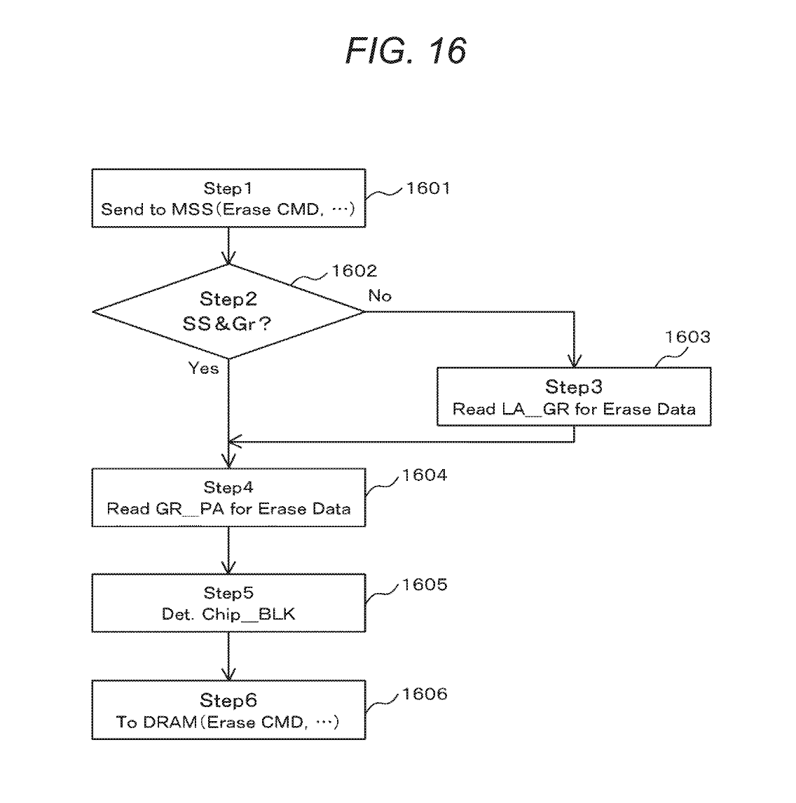

Processing of the memory subsystem control circuit 0107 in data erasing will be described based on FIG. 16.

The memory access control circuit 0201 in the memory subsystem control circuit 0107 forwards, to the memory subsystem 0104, a data erase command stored in the memory 0106 managed by the host 0102, and a super step number, a group number, a data type identifier of data to be erased. Next, the memory access control circuit 0201 stores an erase command in the command buffer 0202 and stores a super step number, a group number, and a data type identifier in the tag buffer 0205 (Step 1 (Send to MSS) 1601). Alternatively, first, the memory access control circuit 0201 forwards, to the memory subsystem 0104, a data erase command stored in the memory 0106 managed by the host 0102 and a logical address and a data size of data to be erased. Then, a logical address and a size of data to be erased are stored in an address buffer (Step 1 (Send to MSS) 1601).

Next, the garbage collection elimination control block 0207 refers to the tag buffer 0205 and confirms whether a super step number, a group number, and a data type identifier of the data to be erased are forwarded from the host 0102 (Step 2 (SS&GR?) 1602). Consequently, if these are stored in the tag buffer 0205, Step 4 1604 is performed (Step 2 1602 is Yes). If not, Step 3 1603 is performed (Step 2 1602 is No).

In Step 3 1603, the garbage collection elimination control block 0207 reads a logical address and a data size of data to be erased from the address buffer 0204. After that, the garbage collection elimination control block 0207 issues a data read command to the DRAM control circuit 0209, reads the table (LA_GR) 0910 illustrated in FIG. 9 (b) from the memory 0109 (Step 3 (Read LA_GR for Erase Data) 1603), specifies a super step number, a group number, and a data type identifier of the data to be erased, and stores them in the tag buffer 0205.

Next, the garbage collection elimination control block 0207 issues a data read command to the DRAM control circuit 0209 and reads the table (GR_PA) 0900 illustrated in FIG. 9(a) from the memory 0109 (Step 4 (Read GR_PA for EraseData) 1604).

The garbage collection elimination control block 0207 reads a super step number, a group number, and a data type identifier from the tag buffer 0205. Further, the garbage collection elimination control block 0207 refers to the table (GR_PA) 0900 read in Step 4 1604 and determines a way and a block of a nonvolatile memory which is a data erase destination (Step 5 (Det. Chip_BLK) 1605).

The garbage collection elimination control block 0207 issues a data write command to the DRAM control circuit 0209, forwards the data erase command from the host 0102 to the memory 0109 from a command buffer, forwards a super step number, a group number, and a data type identifier to the memory 0109 from the tag buffer. Together with these, the garbage collection elimination control block 0207 forwards, to the memory 0109, such as a way and a block of the nonvolatile memory 0108 which is a data erase destination. Further, as necessary, the garbage collection elimination control block 0207 forwards a logical address and a data size of data to be erased from the address buffer 0204 to the memory 0109 (Step 6 (To DRAM) 1606).

(5) Data Processing in Nonvolatile Memory

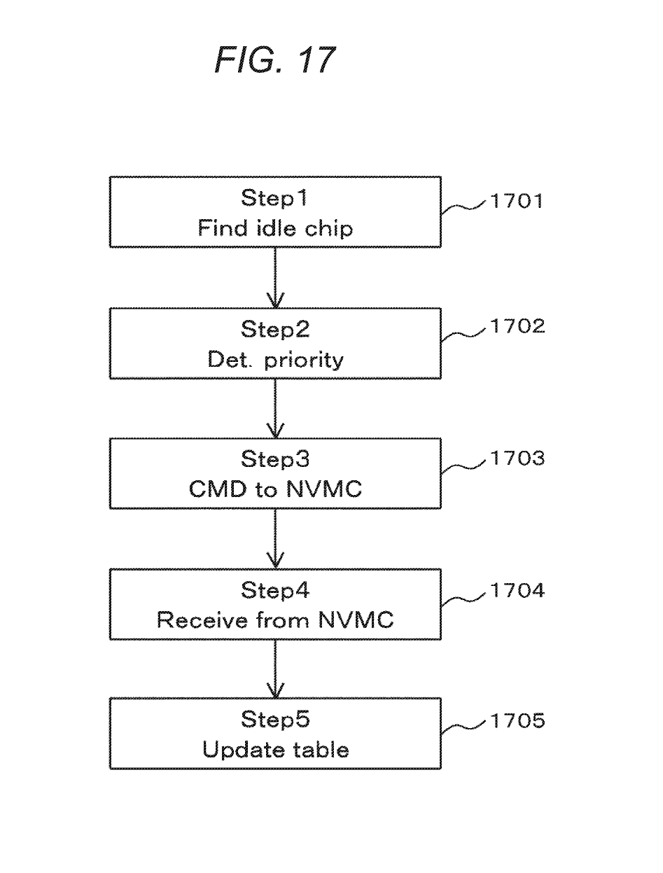

Data processing of the memory subsystem control circuit 0107 in the nonvolatile memory 0108 will be described based on FIGS. 17 to 19.

FIG. 17 is a flowchart of processes applying, to the nonvolatile memory 0108, a write command, a read command, and an erase command written in the memory 0109 in the processes in the above-described (2) to (4). First, the garbage collection elimination control block 0207 issues, to the nonvolatile memory control circuit 0208 of each channel 0210, a command to confirm a state of the nonvolatile memory 0108. In response to the command, the nonvolatile memory control circuit 0208 of each channel 0210 reads a signal of the ready/busy line 0213 connected to each nonvolatile memory 0108 belonging to each channel 0210 and returns a number (Ch, Way) of the nonvolatile memory 0108 in which a process is not performed to the garbage collection elimination control block 0207 (Step 1 (Find idle chip) 1701).

Based on a result of Step 1 1701, the garbage collection elimination control block 0207 issues a read command to the DRAM control circuit 0209, and reads, from the memory 0109, a write command, a read command, and an erase command addressed to the nonvolatile memory 0108 in which a process is not performed. The garbage collection elimination control block 0207 selects one command with the highest priority for each nonvolatile memory 0108 (Step 2 (Det. priority) 1702) and sends the command to each nonvolatile memory control circuit 0208 (Step 3 (CMD to NVMC) 1703). In the case of a data write command to the nonvolatile memory 0108, the garbage collection elimination control block 0207 issues a read command to the DRAM control circuit 0209, reads data to be written from the memory 0109, and sends the data to the nonvolatile memory control circuit 0208 with a write command.

The nonvolatile memory control circuit 0208 of each channel 0210 notifies the garbage collection elimination control block 0207 of process completion as soon as the nonvolatile memory control circuit 0208 confirms that a process in the nonvolatile memory 0108 is completed (Step 4 (Receive from NVMC) 1704). In the case of data reading, read data is also sent to the garbage collection elimination control block 0207 from the nonvolatile memory control circuit 0208. The garbage collection elimination control block 0207 sends the read data to the memory access control circuit 0201. Further, as necessary, the garbage collection elimination control block 0207 issues a write command to the DRAM control circuit 0209 and forwards the read data to the memory 0109. After that, the memory access control circuit 0201 sends the read data to the host 0102.

At the end, the garbage collection elimination control block 0207 updates a table stored in the memory 0109 (step 5 (Update table) 1705). A table to be updated differs depending on process contents in the nonvolatile memory 0108. A reading process, a writing process, and an erasing process will be separately described below.

### (i) Update of Table in Data Reading

The garbage collection elimination control block 0207 issues a read command to the DRAM control circuit 0209 and reads the table (PBA_ST) 1400 illustrated in FIG. 14 and stored in the memory 0109. Then, the garbage collection elimination control block 0207 updates the status of a block (Status of PBA) 1403 corresponding to a way and a block (Way, PBA) 1401 of the nonvolatile memory 0108 which is a data read destination from “2: before reading” to “3: during reading” or from “3: during reading” to “4: reading is completed”. After that, the garbage collection elimination control block 0207 issues a write command to the DRAM control circuit 0209 and writes the updated table (PBA_ST) 1400 back in the memory 0109.

### (ii) Update of Table in Data Writing

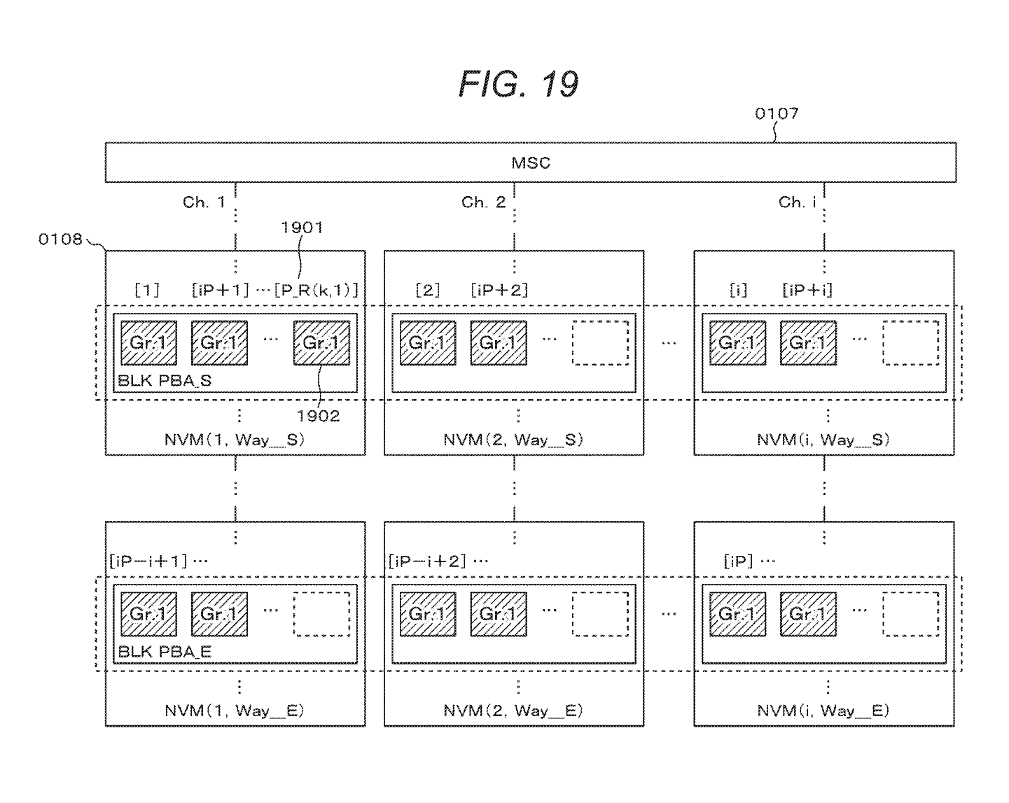

The garbage collection elimination control block 0207 issues a read command to the DRAM control circuit 0209 and reads the table (GR_PTR) 1800 illustrated in FIG. 18 and stored in the memory 0109, a super step number, a group number, and a data type identifier of data to be written, and a write order in a group. By using the above information, the garbage collection elimination control block 0207 updates P_R or P_G of the page pointer 1804 corresponding to a super step (S.S.) 1801 number, a group (Gr.) 1802 number, and a data type identifier (IDX) 1803 of write data in a write page pointer (Ptr) 1804 of the table (GR_PTR) 1800. R of P_R (1, 1) 1805 indicates Result of the data type identifier 1803, (1, 1) indicates that the super step 1801 number is 1, and a group number is 1. G of P_G (1, 1) 1806 indicates that the data type identifier 1803 is Graph. FIG. 19 indicates a relation among the write page pointer 1804 of the table (GR_PTR) 1800, the physical block 0301 of the nonvolatile memory 0108, and the page 0302. As illustrated in FIG. 19, when a write page pointer P_R (k, 1) 1901 in analysis result data in which the super step is k, and the group is 1 is the last page (PG N_pg) 1902 of a block (BLK PBA_S) of the nonvolatile memory (1, Way_S) 0108, it is indicated that P_R (k, 1) pages of the analysis result data of the super step k and the group 1 are already written. Every time when data for one page is written, the garbage collection elimination control block 0207 increases the P_R (k, 1) by one.

(iii) Update of Table in Data Erasing

The garbage collection elimination control block 0207 issues a read command to the DRAM control circuit 0209, reads the table (GR_PA) 0900, the table (LA_GR) 0910, and the table (PBA_ST) 1400, and reads a super step number, a group number, and a data type identifier of data to be erased. In the case where every data of one super step number and group number is erased, the garbage collection elimination control block 0207 updates the table (GR_PA) 0900 and the table (LA_GR) 0910. Further, the block status (Status of PBA) 1403 corresponding to the table (PBA_ST) 1400 is updated to “1: erased”. The garbage collection elimination control block 0207 issues a write command to the DRAM control circuit 0209 and writes the updated tables (GR_PA) 0900, (LA_GR) 0910, and (PBA_ST) 1400 back in the memory 0109.

### G. Summary of Effects

Main effects produced by the above-described configuration and processing are as follows.

If an inexpensive and large capacity memory is usable, a large scale memory necessary for processing large scale data can be inexpensively provided, and in such a case, a high speed data access to the memory can be performed. Specifically, in a server which processes large scale data at a high speed, data is stored in a nonvolatile memory such as a NAND flash memory in which a bit cost is more inexpensive than that of a DRAM. In such a case, the nonvolatile memory is controlled by using a tag number corresponding to the data; therefore garbage collection in the nonvolatile memory is eliminated, and a high speed data access becomes possible. Further, even if a host which performs data processing does not specify an address and a size of data, by specifying a tag number, data can be written in the nonvolatile memory, data can be read from the nonvolatile memory and sent to a host, and data in the nonvolatile memory can be erased.

Furthermore, in the above description, a server 0101 is described as an example. The server 0101 includes the host 0102 which performs data processing, the nonvolatile memory 0108, and the memory subsystem control circuit 0107 which manages the nonvolatile memory 0108. The server 0101 may include the host 0102 which manages a data analysis and the nonvolatile memory 0108, the nonvolatile memory 0108, and a memory subsystem control circuit conforming to the management by the host 0102. Further, an example is described in which a large scale graph is analyzed by dividing in to multiple groups (Gr.) in accordance with a vertex number. However, large scale data processing is not limited to the above example, memory processing may be performed similar to the above processing by dividing large scale data (controlled by key and value) into multiple groups (Gr.) in accordance with Key in MapReduce processing. Further, in a large scale database processing application which secures a large layout on a source code, the above memory processing may be performed by recognizing the same layout as the same group (Gr.), and also an application rage of the above processing includes a case of searching a large scale database and performing data extraction. In these processing, large scale data can be read and written at a high speed. Therefore, a large scale data processing can be accelerated.

With reference to attached drawings, an embodiment has been specifically described above. However, a preferable embodiment is not limited to the above description, and can be variously changed within a range of a gist of the embodiment.

### REFERENCE SIGNS LIST

0101 server
0102 host
0103 interconnect
0104 memory subsystem (MSS)
0105 information processing circuit (CPU)
0106, 0109 memory (DRAM)
0107 memory subsystem control circuit (MSC)
0108 nonvolatile memory (NVM)
0201 memory access control circuit (DMAC)
0202 command buffer (C-BF)
0203 data buffer (D-BF)
0204 address buffer (A-BF)
0205 tag buffer (T-BF)
0206 register (RG)
0207 garbage collection elimination control block (GCLS_CB)
0208 nonvolatile memory control circuit (NVMC)
0209 DRAM control circuit (DRAMC)
0210 channel (Ch 1 to i)
0211 way (Way 1 to j)
0301 block (BLK)
0302 page (PG)
0900 table (GR_PA)
0910 table (LA_GR)
1400 table (PBA_ST)
1800 table (GR_PTR)

1. An information processing device, comprising a host and a memory subsystem, wherein
the host issues a write command or an erase command with tag information corresponding to data to the memory subsystem and comprises an information processing circuit configured to process the data,
the memory subsystem comprises:
a first memory storing management information for managing a second memory;
the second memory having a larger size of a data erase unit than a size of a data write unit and configured to store the data; and
a memory subsystem control circuit configured to write data on the same tag information in the same management unit and write data on the different tag information in the different management unit, based on the management information in which n times of the data erase unit (“n” is a natural number) is a management unit.

2. The information processing device according to claim 1, wherein the host comprises the information processing circuit configured to issue a read command with the tag information to the memory subsystem, and the memory subsystem comprises the memory subsystem control circuit configured to read data corresponding to the same tag information from the second memory and transfers the data to the host.

3. The information processing device according to claim 1, wherein the memory subsystem comprises the memory subsystem control circuit configured to erase the data corresponding to the same tag information from the second memory.

4. The information processing device according to claim 1, wherein the tag information includes information for identifying a group of a data processing unit of the host, information for identifying a super step which is a data processing step of the host, and a data type identifier configured to identify a type of the data processed by the host.

5. The information processing device according to claim 1, wherein the management information includes an association between an address in the second memory of the data and the tag information corresponding to the data, and the management information is stored in a table.

6. The information processing device according to claim 1, wherein the management information includes an association between the tag information and the management unit in which data corresponding to the tag information is written, and the management information is stored in a table.

7. The information processing device according to claim 1, wherein
the memory subsystem comprises:
the first memory accessible at a higher speed than a speed of the second memory; and
the second memory which is a nonvolatile memory.

8. The information processing device according to claim 1, wherein
the memory subsystem comprises:
the first memory configured to store management information for managing a block of the second memory;
the second memory configured to include a plurality of the blocks of a data erase unit and include a plurality of pages of a write unit in the block; and
the memory subsystem control circuit configured to specify the block by referring to the management information and specify the page by calculation.

9. An information processing device, comprising a host and a memory subsystem, wherein
the host issues a write command or an erase command to the memory subsystem, sets n times (“n” is a natural number) of a data erase unit of a memory in the memory subsystem to a management unit, associate between tag information and the management unit by management information, and comprises an information processing circuit configured to process the data, and
the memory subsystem comprises:
the memory having a larger size of the data erase unit than a size of a data write unit and configured to store the data; and
a memory subsystem control circuit configured to, by the write command from the host, write data on the same tag information in the same management unit and write data on the different tag information in the different management unit.

10. The information processing device according to claim 9, wherein the host comprises the information processing circuit configured to issue a read command to the memory subsystem, and the memory subsystem comprises the memory subsystem control circuit configured to read data corresponding to the same tag information from the memory and forward the data to the host.

11. The information processing device according to claim 9, wherein the memory subsystem comprises the memory subsystem control circuit configured to erase the data corresponding to the same tag information from the memory.

12. The information processing device according to claim 9, wherein the tag information includes information for identifying a group which is a data processing unit of the host, information for identifying a super step which is a data processing step of the host, and a data type identifier configured to identify a type of data processed by the host.

13. The information processing device according to claim 9, wherein
the memory subsystem comprises:
a first memory accessible at a higher speed than a speed of the memory; and
the memory which is a nonvolatile memory.

14. The information processing device according to claim 9, wherein
the host specifies a block of the memory by referring to the management information, and comprises an information processing circuit configured to specify a page of the memory by calculation, and
the memory subsystem comprises the memory including a plurality of the blocks which is a data erase unit and including, in the blocks, a plurality of the pages which is a write unit.
